(19) United States
(12) Patent Application Publication
(10) Pub. No.: US 2018/0210383 A1
(43) Pub. Date: Jul. 26, 2018

(54) IMAGE FORMING SYSTEM, IMAGE FORMING CONTROL METHOD, AND NON-TRANSITORY COMPUTER-READABLE RECORDING MEDIUM STORING PROGRAM

(71) Applicant: Konica Minolta, Inc., Tokyo (JP)

(72) Inventor: Hiroshi FURUKAWA, Misato (JP)

(21) Appl. No.: 15/875,627

(22) Filed: Jan. 19, 2018

(30) Foreign Application Priority Data
Jan. 25, 2017 (JP) 2017-011185

(51) Int. Cl. G03G 15/23; G03G 15/00; G03G 15/01; B41J 29/38; G06F 3/12

(52) U.S. Cl. CPC G03G 15/231; G03G 15/5062; G03G 15/0131; G03G 2215/00021; B41J 29/38; G06F 3/1278; G03G 2215/00569; G03G 15/5079

(57) ABSTRACT

Provided is an image forming system in which a plurality of image forming apparatuses are tandem-connected in series. The image forming system comprises a controller that processes image data used for image formation and controlling the image forming apparatus, wherein the controller has a function of outputting an inspection image for obtaining calibration data of the image forming apparatus by the image forming apparatus and enabling acquisition of the reading result read by an image reading unit, and in the function, the controller prepares data for the inspection image to be output by one image forming apparatus and duplicates the data, and transmits inspection image data to each image forming apparatus, and performs control so that image is formed on different transfer media respectively by the respective image forming apparatuses based on the inspection image data received by each image forming apparatus.

The entire disclosure of Japanese patent Application No. 2017-011185, filed on Jan. 25, 2017, is incorporated herein by reference in its entirety

### BACKGROUND

### Technological Field

The present invention relates to an image forming system in which a plurality of image forming apparatuses are tandem-connected in series, an image forming control method, and a non-transitory computer-readable recording medium storing a program.

### Description of the Related Art

In the field of an image forming apparatus for forming an image on a paper, a system in which a plurality of image forming apparatuses are tandem-connected in series is known. In such a system, for example, when forming images on both sides of a paper, by printing one side with an image forming apparatus on the upstream side and forming an image on the other side of the paper with an image forming apparatus on the downstream side, the productivity of duplex printing is improved.

However, when a plurality of image forming apparatuses are tandem-connected in series, since different image is printed by each image forming apparatus, a difference in color taste due to machine difference occurs. Accordingly, it is necessary to acquire calibration data in order to eliminate the difference in output quality in each image forming apparatus and make image quality uniform among the image forming apparatuses. Therefore, it is possible to print an inspection image on the paper by each image forming apparatus, and obtain a calibration data according to the result of reading the inspection image.

As a method of adjusting a serial tandem system, for example, Japanese Patent Laid-Open No. 2004-336335 states that nonvolatile data held in each image forming apparatus and in which control conditions related to the operation of each image forming apparatus are determined can be read and rewritable by the control apparatus connected to the system.

In Japanese Patent Laid-Open No. 2015-161924, a technique is shown in which process conditions are changed a plurality of times within an adjustable range in conjunction with each image forming apparatus and a test chart is output each time the process condition is changed a plurality of times.

In Japanese Patent Laid-Open No. 2007-137012, when the inspection mode is started, an inspection chart is printed by the print engine 201 of the printing unit 200, the same paper is sent to the print engine 301 of the printing unit 300, and an inspection chart is printed on the same side area on which the inspection chart is not printed. Here, the inspection charts of the printing units 200 and 300 are intended not to overlap with each other. Accordingly, in the paper discharging unit 400, printing results are obtained in which inspection charts of both two printing units 200 and 300 are printed on the same side. By visually checking or reading this with the reading unit 451, it can be determined whether the color reproducibility between the two print engines 201, 301 matches.

However, Japanese Patent Laid-Open No. 2004-336335 does not describe a calibration method using inspection images. Further, in Japanese Patent Laid-Open No. 2015-161924, test charts to be printed by the respective image forming apparatuses are individually set and printed, which increases the processing load.

Furthermore, in a technique disclosed in Japanese Patent Laid-Open No. 2007-137012, to print inspection charts of two printing units on one page, it is necessary to prepare image data to be printed by two unites at the time of chart creation, and for example, in the upper half, the chart image must be generated as data for printing by the main machine, and the lower half as data for printing by the sub machine. Therefore, there is a problem that an algorithm dedicated to the system tandem-connected in series is required to generate the chart image. In addition, since different charts are printed on one page, it is not possible to grasp the state of images, balance, or the like at a paper position.

### SUMMARY

The present invention has been made in view of the above described problem, and an object of the present invention is to provide an image forming system, an image forming control method, and a non-transitory computer-readable recording medium storing a program, capable of obtaining calibration data without complicated processing in a system in which a plurality of image forming apparatuses are tandem-connected in series.

To achieve at least one of the abovementioned objects, according to an aspect, an image forming system reflecting one aspect of the present invention is an image forming system, in which a plurality of image forming apparatuses each having an image forming unit that forms an image on a recording medium are tandem-connected in series, comprising:

a controller that processes image data used for image formation by the image forming unit and controlling the image forming apparatus, wherein

the controller has a function of outputting an inspection image for obtaining calibration data of the image forming apparatus by the image forming apparatus and enabling acquisition of a reading result read by an image reading unit, and

in the function, the controller prepares data for the inspection image to be output by one image forming apparatus and duplicates the data, transmits one of the original inspection image data and the duplicated inspection image data to each image forming apparatus, and performs control so that image is formed on different transfer media respectively by the respective image forming apparatuses based on the inspection image data received by each image forming apparatus.

To achieve at least one of the abovementioned objects, according to an aspect, an image forming control method reflecting one aspect of the present invention is an image forming control method for controlling image formation by the image forming system, in which a plurality of image forming apparatuses each having the image forming unit that forms an image on a recording medium are tandem-connected in series, comprising;

a function of outputting an inspection image for obtaining calibration data of the image forming apparatus by the image forming apparatus and enabling acquisition of a reading result read by an image reading unit, wherein

in the function, data for the inspection image to be output by one image forming apparatus is prepared and the data is duplicated, and the original inspection image data and the duplicated inspection image data are transmitted to each image forming apparatus, and control is performed so that image is formed on different transfer media respectively by the respective image forming apparatuses based on the inspection image data received by each image forming apparatus.

To achieve at least one of the abovementioned objects, according to an aspect, a non-transitory recording medium storing a program reflecting one aspect of the present invention is a non-transitory computer-readable recording medium storing a program executed on a computer that controls an image forming system, in which a plurality of image forming apparatuses each having an image forming unit that forms an image on a recording medium are tandem-connected in series,

the program causes the computer to output an inspection image for obtaining calibration data of the image forming apparatus by the image forming apparatus and enable acquisition of a reading result read by the image reading unit and

in the output of the image forming apparatus, prepare data for the inspection image to be output by one image forming apparatus and duplicate the data, and transmit the original inspection image data and the duplicated inspection image data to each image forming apparatus, and perform image formation on different transfer media respectively by the respective image forming apparatuses based on the inspection image data received by each image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an outline of a mechanical configuration of an image forming system according to an embodiment of the present invention;

FIG. 2 is a diagram showing a control block of the image forming system according to an embodiment of the present invention;

FIG. 3 is a diagram showing a schematic block of the image forming system and a flow of data when duplicating data for chart images received by a main machine and transmitting data for duplicated chart images to a sub machine according to an embodiment of the present invention;

FIG. 4 is a flow chart showing a procedure for duplicating data for a chart image by the main machine and transmitting data for duplicated chart images to the sub machine according to an embodiment of the present invention;

FIG. 5 is a flow chart showing a procedure for printing a chart image on the main machine according to an embodiment of the present invention;

FIG. 6 is a flow chart showing a procedure for printing a chart image on the sub machine according to an embodiment of the present invention;

FIG. 7 is a diagram showing a relationship of each data when a system controller has calibration data considering a difference between the main machine and the sub machine according to an embodiment of the present invention;

FIG. 8 is a flow chart showing a procedure in which the system controller creates calibration data for the main machine and the sub machine according to an embodiment of the present invention;

FIG. 9 is a diagram showing a relationship of each data when the system controller has calibration data for one machine according to an embodiment of the present invention; and

FIG. 10 is a flowchart showing a procedure when the system controller creates calibration data for one machine according to an embodiment of the present invention.

### DETAIL DESCRIPTION OF EMBODIMENTS

Hereinafter, an embodiment of the present invention will be described with reference to the drawings. However, the scope of the invention is not limited to the disclosed embodiments.

An image forming system according to an embodiment of the present invention will be described below.

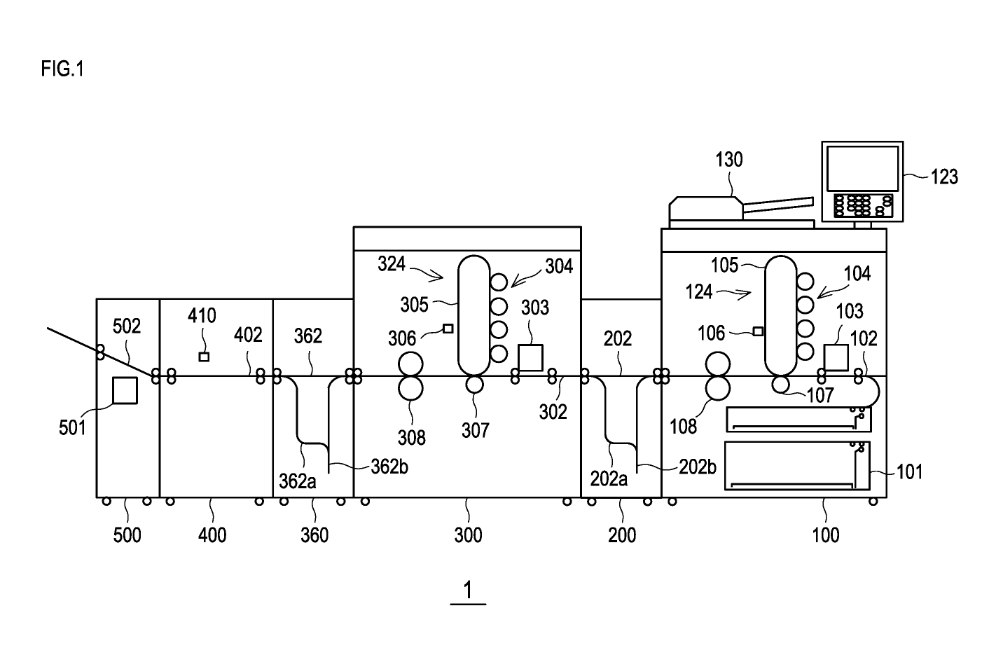

FIG. 1 is a diagram showing a mechanical outline of the image forming system 1.

The image forming system 1 includes, in order from an upstream side in a paper conveyance direction, a first image forming apparatus 100, a first reversing apparatus 200, a second image forming apparatus 300, a second reversing apparatus 360, an image reader 400, and a post processor 500. It is possible to convey a paper and communicate between the apparatuses.

The image forming system 1 has a configuration in which the first image forming apparatus 100 and the second image forming apparatus 300 are tandem-connected in series.

Further, the image forming system 1 includes the first image forming apparatus 100, the first reversing apparatus 200, the second image forming apparatus 300, the second reversing apparatus 360, the image reader 400, and the post processor 500, but the configuration of the image forming system of the present invention is not limited to this, and the image forming system may be constituted by the first image forming apparatus 100 and the second image forming apparatus 300. Further, the number and types of the apparatuses in the image forming system of the present invention are not limited to the above, and may include other apparatuses. For example, a paper feeder having a plurality of paper feeding trays may be provided in the preceding stage of the first image forming apparatus 100. Further, in the image forming system of the present invention, the image forming apparatuses connected in series may be three or more.

In the image forming system 1, duplex printing can be performed by printing on the first side of a paper by the first image forming apparatus, reversing the paper by the first reversing apparatus 200, and printing on the second side opposite to the first side of the paper by the second image forming apparatus 300.

In this embodiment, appropriately, the first image forming apparatus 100 is referred to as a main machine and the second image forming apparatus 300 is referred to as a sub machine, but in terms of control, it is also possible to reverse the main machine and the sub machine.

First, the first image forming apparatus 100 will be described.

The first image forming apparatus 100 includes an operation display unit 123 on the upper part of a housing. The operation display unit 123 is composed of a display unit including an LCD and an operation unit, and can display information and operation input. The operation display unit 123 may be a unit in which the operation unit and the display unit are integrated, such as an LCD having a touch panel.

The first image forming apparatus 100 includes a document feeding unit 130 on the upper part of the housing. The document feeding unit 130 can automatically feed the document and can read the image of the document by a scanner which is not shown. It is also possible to read the document on a platen glass which is not shown.

The housing of the first image forming apparatus 100 includes a paper feeding tray 101 inside. Paper is stored in the paper feeding tray 101. The paper corresponds to the recording medium of the present invention. In the present invention, the material of the recording medium is not limited to paper, and the recording medium of desired material such as cloth or plastic can be used.

A conveyance path 102 is connected to the paper feeding tray 101. The conveyance path 102 conveys a paper supplied from the paper feeding tray 101 and a paper supplied from the outside of the housing. The downstream side of the conveyance path 102 is connected to a conveyance path 202 of the first reversing apparatus 200 at the subsequent stage.

In the middle of the conveyance path 102, a head detecting unit 103 is provided. The head detecting unit 103 can be constituted by an optical sensor, and the end portion of the conveyed paper can be detected by ON/OFF of light detection. The timing of image forming can be determined based on the detection result by the head detecting unit 103.

In the middle of the conveyance path 102, an image forming unit 124 is provided at a position on the downstream side of the head detecting unit 103. The image forming unit 124 forms an image on a paper conveyed through the conveyance path 102.

In the image forming unit 124, a photoreceptor 104 for each color, a secondary transfer unit 107, and a reading unit 106 are disposed around an intermediate transfer belt 105 in the order of the rotation direction of the belt. The secondary transfer unit 107 is provided at a position sandwiching the conveyance path 102 with respect to the intermediate transfer belt 105. Further, a fixing unit 108 is disposed in the middle of the conveyance path 102 and on the downstream side of the secondary transfer unit 107. In addition, around the photoreceptor 104, a charger, an LD, a developing unit, and the like which are not shown are provided respectively.

Although the first image forming apparatus 100 has a configuration for performing color printing, as the present invention, it is also possible to make an apparatus which performs monochrome printing.

Next, the first reversing apparatus 200 will be described.

The first reversing apparatus 200 has a conveyance path 202. The upstream side of the conveyance path 202 is connected to the conveyance path 102 of the first image forming apparatus 100 and the downstream side is connected to a conveyance path 302 of a second image forming apparatus 300 in the subsequent stage.

A reversing conveyance path 202a branches off in the middle of the conveyance path 202, and the downstream side of the reversing conveyance path 202a joins the conveyance path 202 on the upstream side of the branching point. The reversing conveyance path 202a has a reversing unit 202b which can invert the front and back of a paper to convey it.

In the first reversing apparatus 200, the paper can be reversed. When the paper is reversed, the paper is conveyed from the conveyance path 202 to the reversing conveyance path 202a, by inverting the front and back of the paper at the reversing unit 202b of the reversing conveyance path 202a, and conveying the paper to the downstream side of the reversing conveyance path 202a, the front and back of the paper are reversed. The reversed paper is returned to the conveyance path 202 and can be conveyed to the downstream side of the conveyance path 202. When the paper is not reversed, the paper is conveyed as it is in the conveyance path 202 without being sent to the reversing conveyance path 202a.

Next, the second image forming apparatus 300 will be described.

The second image forming apparatus 300 is provided with a conveyance path 302, the upstream side of the conveyance path 302 is connected to the conveyance path 202 of the first reversing apparatus 200 of the preceding stage, and the downstream side of the conveyance path 302 is connected to a conveyance path 362 of the second reversing apparatus 360 at the subsequent stage. The conveyance path 302 conveys a paper conveyed from the first reversing apparatus 200.

In the vicinity of the conveyance path 302, a head detecting unit 303 is provided. The head detecting unit 303 can be constituted by an optical sensor, and the end portion of a conveyed paper can be detected by ON/OFF of light detection. The timing of image forming can be determined based on the detection result at the head detecting unit 303.

In the vicinity of the conveyance path 302, an image forming unit 324 is provided at a position on the downstream side of the head detecting unit 303. The image forming unit 324 can form an image on a paper conveyed through the conveyance path 302.

In the image forming unit 324, around an intermediate transfer belt 305, a photoreceptor 304 for each color, a secondary transfer unit 307, and a reading unit 306 are disposed in the order of the rotation direction of the belt. Further, a fixing unit 308 is disposed in the middle of the conveyance path 302, and on the downstream side of the secondary transfer unit 307. In addition, around the photoreceptor 304, a charger, an LD, a developing unit, and the like which are not shown are provided respectively.

Although the second image forming apparatus 300 has a configuration for performing color printing, it is also possible to make an apparatus which performs monochrome printing.

Next, the second reversing apparatus 360 will be described.

The second reversing apparatus 360 has a conveyance path 362. The upstream side of the conveyance path 362 is connected to the conveyance path 302 of the second image forming apparatus 300 and the downstream side of the conveyance path 362 is connected to a conveyance path 402 of the image reader 400 at the subsequent stage. A reversing conveyance path 362a branches off in the middle of the conveyance path 362, and the downstream side of the reversing conveyance path 362a joins the conveyance path 362 on the upstream side of the branching point. The reversing conveyance path 362a has a reversing unit 362b which can be conveyed by inverting the front and back.

In the second reversing apparatus 360, a paper can be reversed. When the paper is reversed, the paper is conveyed from the conveyance path 362 to the reversing conveyance path 362a, by inverting the front and back of the paper at the reversing unit 362b of the reversing conveyance path 362a and conveying it to the downstream side of the reversing conveyance path 362a, the front and back of the paper are reversed. The reversed paper is returned to the conveyance path 362 and can be conveyed to the downstream side of the conveyance path 362. When the paper is not reversed, the paper is conveyed as it is in the conveyance path 362 without being sent to the reversing conveyance path 362a.

Next, the image reader 400 will be described. The image reader 400 is disposed on the subsequent stage of the second reversing apparatus 360, that is, the following stage side than the first image forming apparatus 100 and the second image forming apparatus 300.

The image reader 400 has a conveyance path 402. The upstream side of the conveyance path 402 is connected to the conveyance path 362 of the second reversing apparatus 360, and the downstream side of the conveyance path 402 is connected to the conveyance path 502 of the post processor 500.

An image reading unit 410 is disposed in the middle of the conveyance path 402. The image reading unit 410 can be constituted by a CMOS sensor, a CCD sensor, or the like, and can read an image on the upper side of a paper. The image reading unit may be a line sensor, or a colorimeter or the like for reading an image at a point. When a colorimeter is used, a chart image for adjustment such as a patch formed on a paper is read with the colorimeter, the reading result is transmitted to another apparatus, and analyzed, thereby each image forming apparatus can be adjusted. The read result may be configured to analyze in the image reader 400.

In this embodiment, the image reader has been described as having one image reading unit, but it may have a plurality of image reading units. In that case, reading of the adjustment data output by a plurality of image forming apparatuses is performed using one image reading unit.

Next, the post processor 500 will be described.

The post processor 500 has a conveyance path 502, and the upstream side of the conveyance path 502 is connected to the conveyance path 402 of the image reader 400.

A post-processing unit 510 is provided in the middle of the conveyance path 502, and the post-processing unit can perform appropriate processing such as stapling, punching, booklet processing and the like on a paper on the conveyance path, or may perform a plurality of post-processing. Further, a paper may be discharged without performing post-processing by the post processor 500.

When an image is formed on a paper by the first image forming apparatus, a latent image is formed on the photoreceptor 104 charged based on an image data by the LD, and the developing unit develops the latent image to create a toner image. The toner image on the photoreceptor 104 is transferred to the intermediate transfer belt 105, and the image on the intermediate transfer belt 105 is transferred to the paper conveyed along the conveyance path 102 by the secondary transfer unit 107. The paper is conveyed from the paper feeding tray 101 and the like. Thereafter, heat and pressure are applied to the paper conveyed by the conveyance path 102 by the fixing unit 108, thereby the image is fixed on the paper. The paper on which the image has been fixed is conveyed to the outside of the first image forming apparatus as it is in face-up state without reversing the paper by the first reversing apparatus 200.

The reading unit 106 disposed around the intermediate transfer belt 105 is located on the downstream side of the secondary transfer unit 107 in the rotation direction of the belt, and the adjustment patches and patterns formed on the intermediate transfer belt 105 can be read.

The paper on which the image is formed is discharged from the first image forming apparatus 100, inverted by the first reversing apparatus 200 as necessary, and conveyed to the second image forming apparatus 300. For example, when printing is performed on a paper side different from the paper side on which the image is formed by the first image forming apparatus 100, after forming an image with the first image forming apparatus 100, the first reversing apparatus 200 reverses the paper and conveys the paper to the second image forming apparatus 300, and an image is formed on the upper side of the paper by the second image forming apparatus 300.

When an image is formed on a paper by the second image forming apparatus 300, a latent image is formed on the photoreceptor 304 charged based on the image data by the LD, the latent image is developed by the developing unit to form a toner image, the toner image is transferred onto the intermediate transfer belt 305, and in the secondary transfer unit 307, the image on the intermediate transfer belt 305 is transferred to the paper. The paper is conveyed from the paper feeding tray 101 or the like. Thereafter, heat and pressure are applied to the paper by the fixing unit 308, thereby fixing the image on the paper. The paper on which the image is formed is conveyed to the outside of the apparatus as it is in face-up.

Further, in the vicinity of the intermediate transfer belt 305, the reading unit 306 is installed on the downstream side of the secondary transfer unit 307 in the rotation direction of the belt. The reading unit 306 can read adjustment patches and patterns formed on the intermediate transfer belt 305.

When no image is formed on the paper on which the image is formed by the first image forming apparatus 100 by the second image forming apparatus 300, the image is not formed in the image forming unit 324, and the paper is conveyed to the downstream side through the conveyance path 302. When image formation is not performed by the first image forming apparatus 100, and image formation is performed only by the second image forming apparatus 300, the paper fed in the first image forming apparatus 100 is discharged as it is without performing image formation in the first image forming apparatus 100, and loaded into the second image forming apparatus 300 to form an image.

Next, the electrical configuration of the image forming system 1 will be described.

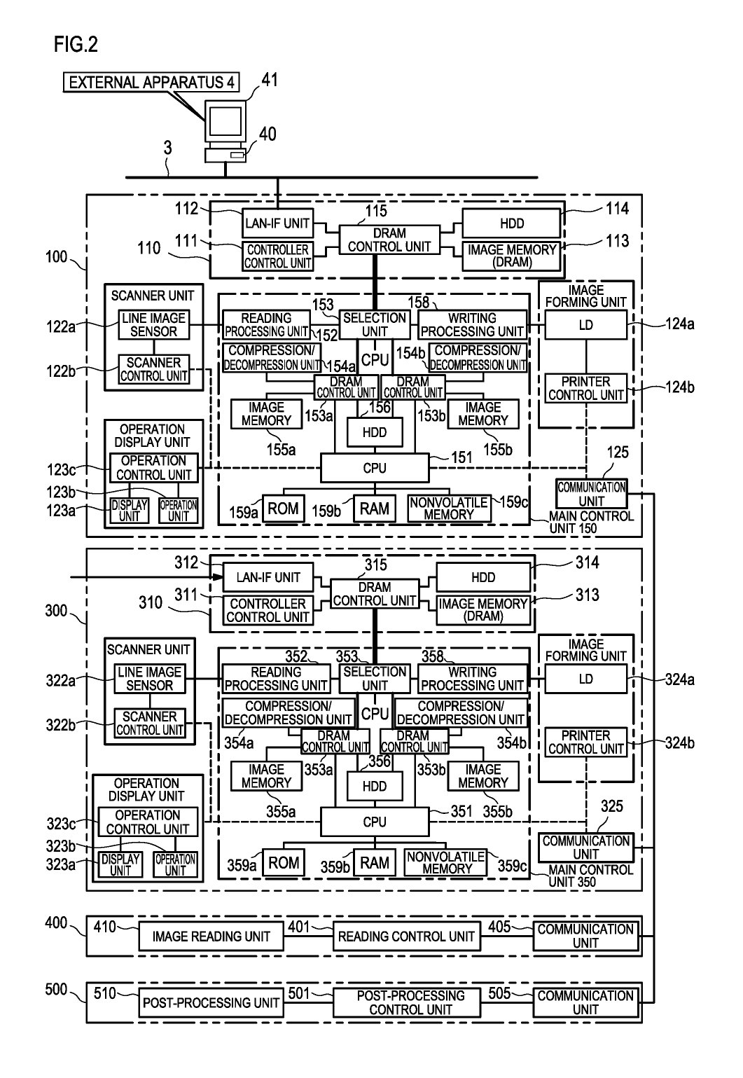

FIG. 2 is a functional block diagram of the image forming system 1.

The first image forming apparatus 100 includes a printer controller 110, a scanner unit 122, an operation display unit 123, an image forming unit 124, a communication unit 125, and a main control unit 150, as main configurations.

The printer controller 110 includes a controller control unit 111, a LAN-IF unit 112, an image memory (DRAM) 113, an HDD 114, and a DRAM control unit 115, and the controller control unit 111, the LAN-IF unit 112, the image memory (DRAM) 113 and the HDD 114 are connected to the DRAM control unit 115, respectively. Further, the DRAM control unit 115 is connected to a selection unit 153 of the main control unit 150 via a PCI bus.

The controller control unit 111 includes a CPU, a ROM, a RAM, and the like, and controls the printer controller based on a program operated by the CPU.

The LAN-IF unit 112 is connected to a LAN 3, and can communicate with an external apparatus 4 such as a PC connected to the LAN 3. Job data and the like can be received from the external apparatus 4 and jobs can be executed in the first image forming apparatus based on the received job data, and it is possible to communicate with other apparatuses of the image forming system 1 and to output jobs in conjunction with other apparatuses. As job data, in addition to performing image formation, it is also possible to form adjustment chart images and perform adjustment based on the reading result of the formed adjustment chart images.

The external apparatus 4 can transmit an image quality adjustment execution instruction and an adjustment chart image data to the first image forming apparatus 100.

When image quality adjustment is performed, data of an adjustment chart image for image quality adjustment and the like may be provided in the storage unit inside the main body, and reading may be performed based on the instruction of an operator to perform adjustment. For example, adjustment of the image forming system 1 can be performed based on an operation on the operation display unit 123. The adjustment chart image corresponds to the inspection image of the present invention.

When image data for printing is acquired in the first image forming apparatus 100, image data can be received via the LAN-IF unit 112. The received image data is stored in the image memory (DRAM) 113 or the HDD 114 via the DRAM control unit 115.

The scanner unit 122 has a line image sensor 122a and a scanner control unit 122b. The line image sensor 122a and the scanner control unit 122b are electrically connected to each other and the scanner control unit 122b controls the line image sensor 122a so that an image of a paper fed by the document feeding unit 130 or a paper on the platen glass can be optically read.

The line image sensor 122a is connected to a reading processing unit 152 of the main control unit 150 and the scanner control unit 122b is connected to a CPU 151 of the main control unit 150.

The operation display unit 123 has a display unit 123a, an operation unit 123b, and an operation control unit 123c. The operation control unit 123c is connected to the display unit 123a and the operation unit 123b.

The display unit 123a can be constituted by an LCD, and the operation unit can be constituted by a touch panel, an operation button outside the LCD, or the like. The operation control unit 123c includes a CPU, a ROM, a RAM, a program operated on the CPU, and the like, and controls the operation display unit 123. In the operation display unit 123, it is possible to display setting screens and operation screens, display warnings, notify users, accept operation inputs, and the like.

The image forming unit 124 includes an LD 124a, a printer control unit 124b, and a charger, a photoreceptor, a developing unit, a transfer unit, a fixing unit, and the like, which are not shown. The printer control unit 124b can control the entire image forming unit 124, and the printer control unit 124b controls each unit according to an instruction from the CPU 151 to form an image. When image formation is performed, the LD 124a forms a latent image on the photoreceptor based on image data, the developing unit develops the latent image to create a toner image, the transfer unit transfers the toner image to the paper, and the fixing unit fixes the toner image on the paper by heat or the like. The image forming unit may perform monochrome printing or color printing.

Next, the main control unit 150 will be described. The main control unit 150 controls the first image forming apparatus 100.

The main control unit 150 has a CPU 151. The CPU 151 is connected to DRAM control units 153a, 153b, a HDD 156, a ROM 159a, a RAM 159b, and a nonvolatile memory 159c. The DRAM control unit 153a is connected to a selection unit 153, a compression/decompression unit 154a, and an image memory 155a, and the DRAM control unit 153b is connected to the selection unit 153, the compression/decompression unit 154b, and an image memory 155b.

The selection unit 153 is connected to a reading processing unit 152 and a writing processing unit 158 and further, connected to the DRAM control unit 115 via the PCI bus. The reading processing unit 152 is connected to the line image sensor 122a of the scanner unit 122 and the writing processing unit 158 is connected to the LD 124 of the image forming unit 124.

Further, the CPU 151 is connected to the scanner control unit 122b, the operation control unit 123c, the printer control unit 124b, and the communication unit 125. The communication unit 125 is connected to a communication unit 325 of the second image forming apparatus 300, a communication unit 405 of the image reader 400, and a communication unit 505 of the post processor.

The CPU 151 controls the entirety of the first image forming apparatus 100 by executing a program and grasps the state of the entire first image forming apparatus 100. The CPU 151 and a program operated by the CPU 151 function as an image forming controller of the present invention.

Further, the program may include a program that processes image data used in the image forming system 1 and controlling each image forming apparatus. In that case, the program operating on the CPU 151 and the CPU 151 functions as a system controller. The system controller may be outside the housing of the image forming apparatus and communicably connected to the image forming apparatus, and in the image forming apparatus, may be provided as a separate configuration from the image forming controller. The image forming controller and the system controller are included in the controller of the present invention, and the controller corresponds to the computer on which the program of the present invention is executed. The program may be stored in a removable recording medium and may be distributed.

The program may be stored in the ROM 159a or may be stored in the HDD 156 or an external storage medium. It may be distributed by removing the storage medium.

When executing the adjustment of the first image forming apparatus 100, the image forming controller of the first image forming apparatus can duplicate the data of the adjustment chart image received from the system controller and transmit the data of the duplicated adjustment chart image to the second image forming apparatus 300 via the communication unit 125. Further, it can also adjust the image forming apparatus based on the result of reading the adjustment chart image.

Data duplication may be performed by the system controller and the duplicated data may be transmitted to the image forming apparatus.

The RAM 159b can be used as a work memory when the CPU 151 executes the program, and the nonvolatile memory 159c stores user data, system data, paper setting, operation parameters, various set values, and the like. The nonvolatile memory 159c stores adjustment data, various parameters for creating calibration data based on the reading result, and the like. The adjustment data can also be obtained from the outside. There may be a plurality of adjustment data.

The reading processing unit 152 performs predetermined processing on the data acquired by the scanner unit 122. For example, it performs various processes such as analog signal processing, A/D (analog to digital) conversion processing, shading processing, and the like on the analog image signal input from the scanner unit 122, generates digital image data, and outputs it to the selection unit 153.

The selection unit 153 selects one of the DRAM control unit 153a and the DRAM control unit 153b based on an instruction from the CPU 151. It can be selected on the data read side or write side.

In addition, the selection unit 153 is connected to the DRAM control unit 115 of the printer controller 110 via the PCI bus, and can transmit and receive data between the printer controller 110 and the main control unit 150.

The DRAM control unit 153a controls writing of data to the image memory 155a and reading of data from the image memory 155a, and performs control at the time of compressing or decompressing image data at the compression/decompression unit 154a.

The DRAM control unit 153b controls writing of data to the image memory 155b and reading of data from the image memory 155b, and performs control at the time of compressing or decompressing image data at the compression/decompression unit 154b.

The compression/decompression units 154a and 154b can compress the image data and decompress the compressed image data. The compressed or decompressed data is stored in the image memory 155a or the image memory 155b.

Data (job data), image data, setting data, and the like of the print job received from the printer controller 110 are stored in the HDD 156.

The writing processing unit 158 outputs a signal for controlling the LD 124a of the image forming unit 124 according to the image data read out from the image memory 155a and the image memory 155b and decompressed.

Next, the electrical configuration of the second image forming apparatus 300 will be described.

The second image forming apparatus 300 has a printer controller 310, a scanner unit 322, an operation display unit 323, an image forming unit 324, a communication unit 325, and a main control unit 350, as main configurations.

The printer controller 310 includes a controller control unit 311, a LAN-IF unit 312, an image memory (DRAM) 313, an HDD 314, and a DRAM control unit 315. These configurations are the same as the configuration of the printer controller 110 in the first image forming apparatus 100, and the same operation is performed, thereby details are omitted. In the second image forming apparatus 300, the printer controller 310 may not be provided.

The scanner unit 322 has a line image sensor 322a and a scanner control unit 322b, the line image sensor 322a and the scanner control unit 322b are electrically connected, and the scanner control unit 322b controls the line image sensor 322a.

The line image sensor 322a is connected to a reading processing unit 352 of the main control unit 350, and the scanner control unit 322b is connected to a CPU 351 of the main control unit 350.

In the second image forming apparatus 300, the scanner unit 322 may not be provided.

The operation display unit 323 has a display unit 323a, an operation unit 323b, and an operation control unit 323c. The operation control unit 323c is connected to the display unit 323a and the operation unit 323b. The display unit 323a can be constituted by an LCD, and the operation unit can be constituted by a touch panel, an operation button outside the LCD, or the like. The operation control unit 323c is constituted by a CPU, a ROM, a RAM, a program operated on the CPU, and the like, and controls the operation display unit 323. On the operation display unit 323, it is possible to display setting screens and operation screens, display warnings, notify users, accept operation inputs, and the like.

In the second image forming apparatus, the operation display unit 323 may not be provided. In that case, setting and display of the second image forming apparatus 300 may be performed via the operation display unit 123 of the first image forming apparatus 100.

The image forming unit 324 includes an LD 324a, a printer control unit 324b, and a charger, a photoreceptor, a developing unit, a transfer unit, a fixing unit, and the like which are not shown. The printer control unit 324b controls the entire image forming unit 324. The printer control unit 324b controls each unit according to an instruction from the CPU 351 to form an image. The operation of the image forming unit 324 is the same as that of the image forming unit 124 of the first image forming apparatus 100.

The main control unit 350 controls the second image forming apparatus 300.

The main control unit 350 has a CPU 351. The CPU 351 is connected to DRAM control units 353a and 353b, a HDD 356, a ROM 359a, a RAM 359b, and a nonvolatile memory 359c. The DRAM control unit 353a is connected to a selection unit 353, a compression/decompression unit 354a, and an image memory 355a, and the DRAM control unit 353b is connected to the selection unit 353, a compression/decompression unit 354b, and an image memory 355b.

The selection unit 353 is connected to the reading processing unit 352 and a writing processing unit 358 and further connected to the DRAM control unit 315 via the PCI bus. The reading processing unit 352 is connected to the line image sensor 322a of the scanner unit 322 and the writing processing unit 358 is connected to the LD 324 of the image forming unit 324.

Further, the CPU 351 is connected to the scanner control unit 322b, the operation control unit 323c, the printer control unit 324b, and the communication unit 325. The communication unit 325 is connected to the communication unit 125 of the first image forming apparatus 100, the communication unit 405 of the image reader 400, and the communication unit 505 of the post processor.

The CPU 351 controls the entirety of the second image forming apparatus 300 by executing a program to grasp the state of the entire second image forming apparatus 300. The CPU 351 and a program operated by the CPU 351 can function as an image forming controller for controlling the second image forming apparatus. The program may be stored in the ROM 359a or may be stored in the HDD 356 or the external storage medium. It may be circulated by removing the storage medium. The image forming controller of the second image forming apparatus is included in the controller of the present invention together with the image forming controller and the system controller of the first image forming apparatus 100 described above and the controller corresponds to the computer on which the program of the present invention is executed.

In the case of performing the image quality adjustment of the second image forming apparatus, the image forming control section forms an adjustment chart image on the paper based on the received data of the adjustment chart image, and analyzes the reading result obtained by reading the adjusting chart image to adjust the image quality. In the case of performing adjustment, a reading result obtained by reading the adjustment chart image formed by another image forming apparatus is acquired, and it is possible to perform adjustment so that difference from other image forming apparatuses is eliminated or within a predetermined range. The allowable range within the predetermined range is predetermined.

The RAM 359b can be used as a work memory when the CPU 351 executes a program, and the nonvolatile memory 359c stores user data, system data, paper setting, operation parameters, various set values, and the like. The nonvolatile memory 359c stores various parameters and the like necessary for adjusting the image forming unit.

The reading processing unit 352 performs predetermined processing on the data acquired by the scanner unit 322. For example, it performs various processes such as analog signal processing, A/D (analog to digital) conversion processing, shading processing, and the like on the analog image signal input from the scanner unit 322, generates digital image data, and outputs it to the selection unit 353.

The selection unit 353 selects one of the DRAM control unit 353a and the DRAM control unit 353b based on an instruction from the CPU 351. It can be selected on the data read side or write side.

In addition, the selection unit 353 is connected to the DRAM control unit 315 of the printer controller 310 via the PCI bus, and can transmit and receive data between the printer controller 310 and the main control unit 350.

The DRAM control unit 353a controls writing of data to the image memory 355a and reading of data from the image memory 355a, and performs control at the time of compressing or decompressing image data at the compression/decompression unit 354a.

The DRAM control unit 353b controls writing of data to the image memory 355b and reading of data from the image memory 355b, and performs control at the time of compressing or decompressing image data at the compression/decompression unit 354b.

The compression/decompression units 354a and 354b can compress the image data and decompress the compressed image data. The compressed or decompressed data is stored in the image memory 355a or the image memory 355b.

Data (job data), image data, setting data, and the like of the print job received from the printer controller 310 are stored in the HDD 356. The HDD 356 and the nonvolatile memory 359c can be used as the storage unit of the present invention.

The writing processing unit 358 outputs a signal for controlling the LD 324a of the image forming unit 324 according to the image data read out from the image memory 355a and the image memory 355b and decompressed.

Next, the electrical configuration of the image reader 400 will be described.

The image reader 400 includes a reading controller 401, a communication unit 405, and an image reading unit 410. The reading controller 401 is connected to the communication unit 405 and the image reading unit 410, and the communication unit 405 is connected to the communication unit 125 of the first image forming apparatus 100, the communication unit 325 of the second image forming apparatus 300, and the communication unit 505 of the post processor, respectively. The reading controller 401 includes a CPU, a ROM, a RAM, and the like, and can control each unit of the image reader 400 by a program operated by the CPU.

The image reading unit 410 is constituted by a reading unit, a transporting unit, and the like, and can read an image on a paper by the control of the reading controller 401. The image reading unit 410 can continuously perform image reading of the conveyed paper. Further, the reading controller 401 can receive control from the outside via the communication unit 405, and can transmit the acquired read image via the communication unit 405 to the image forming controller of the first image forming apparatus 100, the image forming controller of the second image forming apparatus 300, the system controller, and the like. It is also possible to transmit it to an information processor connected to the first image forming apparatus 100.

In the first image forming apparatus 100 and the second image forming apparatus 300, it is possible to obtain calibration data such as image density balance, color tone, etc. by using the reading result acquired by the image reader 400.

Next, the electrical configuration of the post processor 500 will be described.

The post processor 500 includes a post-processing control unit 501, a communication unit 505, and a post-processing unit 510. The post-processing control unit 501 is connected to the communication unit 505 and the post-processing unit 510, and the communication unit 505 is connected to the communication unit 125 of the first image forming apparatus 100, the communication unit 325 of the second image forming apparatus 300, and the communication unit 405 of the image reader 400. The post-processing control unit 501 is constituted by a CPU, a ROM, a RAM, and the like, and each unit of the post processor 500 is controlled by a program operated by the CPU. The post-processing unit 510 can perform predetermined post-processing on the conveyed paper. The post-processing control unit 501 can transmit and receive data via the communication unit 505.

### Embodiment 1

Next, the operation of adjusting the image quality of an output image in the image forming system 1 will be described.

The first image forming apparatus 100 and the second image forming apparatus 300 will be described as a main machine and as a sub machine, respectively. In the present invention, either of the first image forming apparatus 100 and the second image forming apparatus 300 may be treated as a main machine, but an apparatus controllably connected to the system controller and capable of communicating with other image forming apparatuses can be used as the main machine. The system controller corresponds to the system controller of the present invention, and performs processing of image data used in the image forming apparatus and control of each image forming apparatus. The system controller may be provided in the image forming apparatus and be included in the same unit together with the image forming controller or may be provided in a unit different from the image forming control section. Further, it may be provided outside the image forming apparatus.

In the case of a serial tandem image forming system, since different images are printed on the front and back sides in the main machine and the sub machine, differences in color taste due to machine differences occur. Therefore, the system controller that controls the image forming apparatus has the calibration data to perform the calibration according to the image forming apparatus. The calibration data corresponds to the calibration data of the present invention. If calibration data is held, calibration can be performed using the calibration data to obtain the same image quality in each image forming apparatus at the time of normal image formation, and the image forming system can be easily returned to the state before calibration.

In the present embodiment, the controller prepares the data of the adjustment chart image for calibration in the same manner as that when only one image forming apparatus is used, transmits the data to the first image forming apparatus 100 (main machine) on the upstream side, duplicates the data of the adjustment chart image in the first image forming apparatus 100, and transmits the data of the duplicated adjustment chart image to the second image forming apparatus so as to obtain the adjustment chart image.

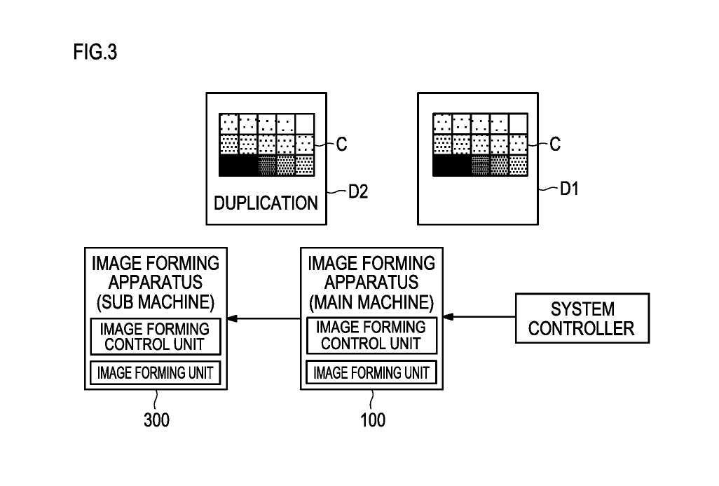

In FIG. 3, the controller prepares data of the adjustment chart image and transmits it to the first image forming apparatus 100 (main machine), and the first image forming apparatus 100 (main machine) transmits the duplicated data to the sub machine.

In the case of adjusting the output in the image forming system 1, as shown in FIG. 3, the system controller transmits the page data D1 for one page having the chart C to the main machine in the same way as in the case of adjusting the single machine. The main machine duplicates the received data, generates the page data D2 of the second page having the chart C, and transmits the data to the sub machine.

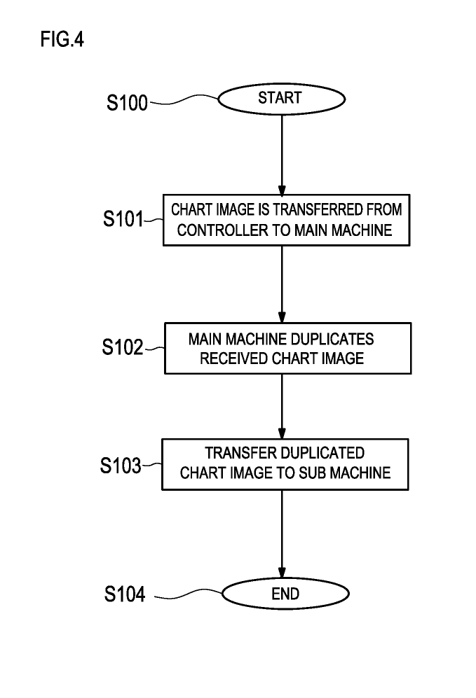

The above operation will be described with reference to the flowchart in FIG. 4.

FIG. 4 is the flowchart showing the procedure of duplicating the data of the chart image by the main image forming apparatus and transmitting it to the sub machine.

When the operation is started (step S100), the chart image is transferred from the controller to the main machine of the image forming apparatus (step S101). The image forming apparatus (main machine) duplicates the page data of the chart image received from the controller (step S102), transfers the data of the duplicated chart image to the sub machine (step S103), and ends the procedure.

Thereafter, in each image forming apparatus, a chart image is formed on the paper based on the received data of the chart image.

In the first image forming apparatus, when the chart is printed as the first page, the first page is printed by the main machine, and the paper is conveyed to the sub machine while keeping face up without reversing the paper. The sub machine discharges it without printing (while keeping face up). Thereafter, the paper discharged from the sub machine is color-measured with the image reader, the reading result is transmitted to the first image forming apparatus, and the first image forming apparatus analyzes the reading result.

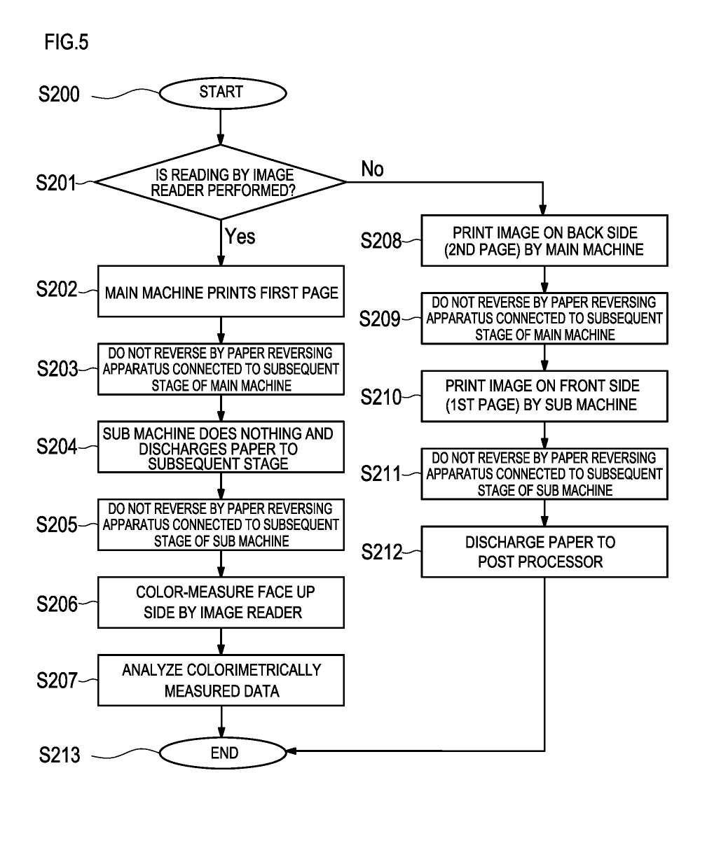

FIG. 5 is a flowchart showing a procedure for printing a chart image in the first image forming apparatus which is the main machine.

When the operation is started (step S200), it is judged whether reading by the image reader is performed (step S201). When reading is performed (step S201, Yes), the process proceeds to step S202. When reading is not to be performed (step S201, No), the process proceeds to step S208.

When reading is performed, that is, when the chart image is printed, the main machine prints the chart image of the first page (step S202). Thereafter, the paper inversion is not performed in the first reversing apparatus 200 connected to the subsequent stage of the main machine (step S203), and the paper is conveyed to the subsequent sub machine while keeping face up. In the sub machine, printing is not performed, and the received paper is discharged to the subsequent stage while keeping face up (step S204). The paper is not inverted by the second reversing apparatus 360 connected to the subsequent stage of the sub machine (step S205), and the paper is conveyed to the subsequent stage while keeping face up. Thereafter, the chart image of the upper side of the paper is color-measured by the image reader (step S206), and the colorimetrically measured data is analyzed by the image forming apparatus having printed the chart image (step S207), and the procedure ends.

When reading by the image reader is not performed (step S201, No), the main machine prints the image on the back side (the second page) (step S208), and the paper inversion is performed by the first reversing apparatus 200 connected to the subsequent stage of the main machine (step S209). The paper is conveyed to the subsequent stage in face down state. Thereafter, the sub-machine prints the front side (the first page) (step S210), the paper reversing apparatus connected to the subsequent stage of the sub machine does not perform the paper inversion (step S211), the paper is set in face down state, conveyed to the subsequent stage, and discharged to the post processor (step S212), and the procedure ends.

When reading by the image reader is performed, and when printing by the sub machine with the chart as the second page is performed, the main machine conveys the paper to the sub machine without doing anything. The sub machine prints the second page, does not invert the paper, and discharges it while keeping face up. The paper discharged from the sub machine is color-measured with the image reader and the result is analyzed.

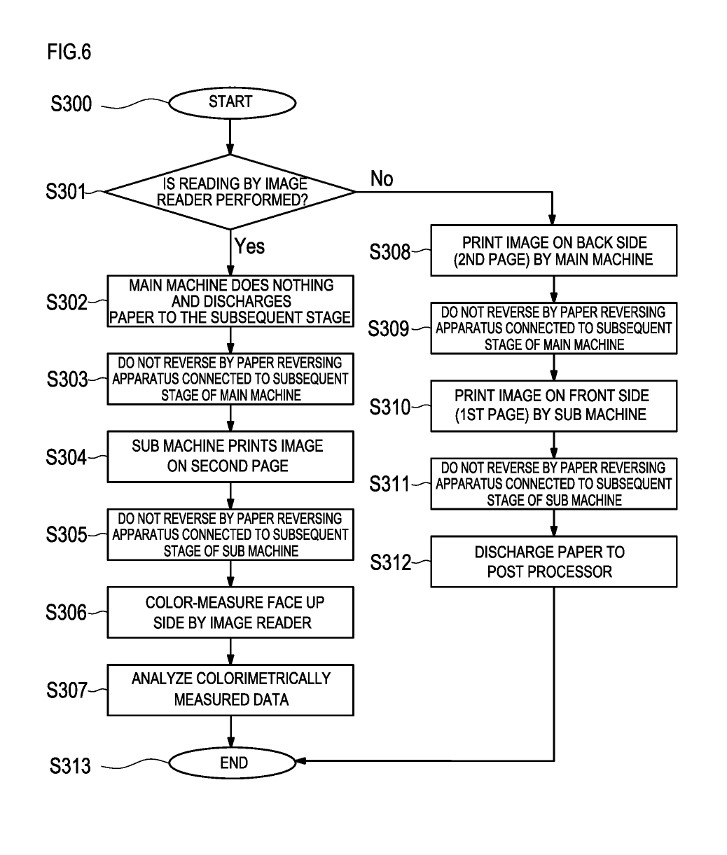

The above operation will be described with reference to the flowchart of FIG. 6.

FIG. 6 is the flowchart showing the procedure for printing the chart image in the first image forming apparatus which is the sub machine.

When the operation is started based on the job, it is judged whether to read with the image reader (step S301). If it is a job to be read (step S301, Yes), the process proceeds to step S302, and the main machine does nothing and discharges the paper to the subsequent stage. When reading is not to be performed (step S301, No), the process proceeds to step S308.

After step S302, the paper inversion is not performed by the first reversing apparatus 200 connected to the subsequent stage of the main machine (step S303), and the paper is conveyed to the subsequent sub machine while keeping face up. The sub machine prints the chart image of the second page duplicated by the main machine (step S304) and discharges the paper to the subsequent stage while keeping face up. In the second reversing apparatus 360 connected to the subsequent stage of the sub machine, the paper inversion is not performed (step S305), and the paper is conveyed to the subsequent stage of the paper while keeping face up. Thereafter, the chart image of the upper side of the paper is color-measured by the image reader (step S306), and the colorimetrically measured data is transmitted to the image forming apparatus having printed the chart image, as the result of the reading. The image forming apparatus which has received the reading result analyzes the colorimetrically measured data (step S307), and ends the procedure.

When reading is not performed by the image reader (step S301, No), the main machine prints an image on the back side (the second page) (step S308) and the paper inversion is performed by the paper reversing apparatus (first reversing apparatus 200) connected to the subsequent stage of the main machine (step S309). The paper is conveyed to the subsequent stage in face down state. Thereafter, the sub machine prints an image on the front side (the first page) (step S310), the paper reversing apparatus (the second reversing apparatus 360) connected to the subsequent stage of the sub machine does not perform the paper inversion (step S311), the paper is set in face down state, conveyed to the subsequent stage, discharged to a post processor (step S312), and the procedure ends.

In the image forming system 1, when adjusting each image forming apparatus in the system, the output of each image forming apparatus is adjusted based on the reading result obtained by reading the adjustment chart image so that the output result of each image forming apparatus is the same.

In this case, when the controller can hold a plurality of calibration data in consideration of the main machine and the sub machine, the image forming apparatuses inform the controller of both the results of reading the chart image printed by the main machine and the sub machine, and the controller creates the calibration data for the main machine and the sub machine. In this case, the controller creates the calibration data so as to eliminate difference in each image forming apparatus. This makes it possible to make the output results of each image forming apparatus the same.

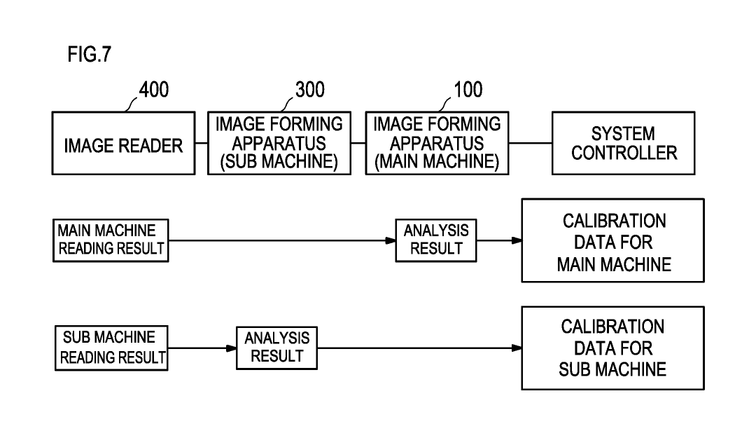

FIG. 7 shows the relationship between the reading result, the analysis result and the calibration data held by the controller when the controller has the calibration data considering the difference between the main machine and the sub machine.

In this case, in the chart image printed by the main machine, the reading result obtained by the image reader is transmitted to the image forming apparatus (the first image forming apparatus 100) of the main machine, and the analysis is performed by the first image forming apparatus 100, and the analysis result is transmitted to the system controller. Similarly, in the chart image printed by the sub machine, the reading result acquired by the image reader is transmitted to the image forming apparatus (the second image forming apparatus 300) of the main machine, and the analysis is performed by the second image forming apparatus 300, the analysis result is transmitted to the system controller. Thereafter, the system controller creates calibration data for the main machine and the sub machine based on the analysis result. The calibration data is calculated by the system controller so that the output results of the main machine and the sub machine are the same. In this figure, although each image forming apparatus analyzes the reading result, analysis may be performed by the controller.

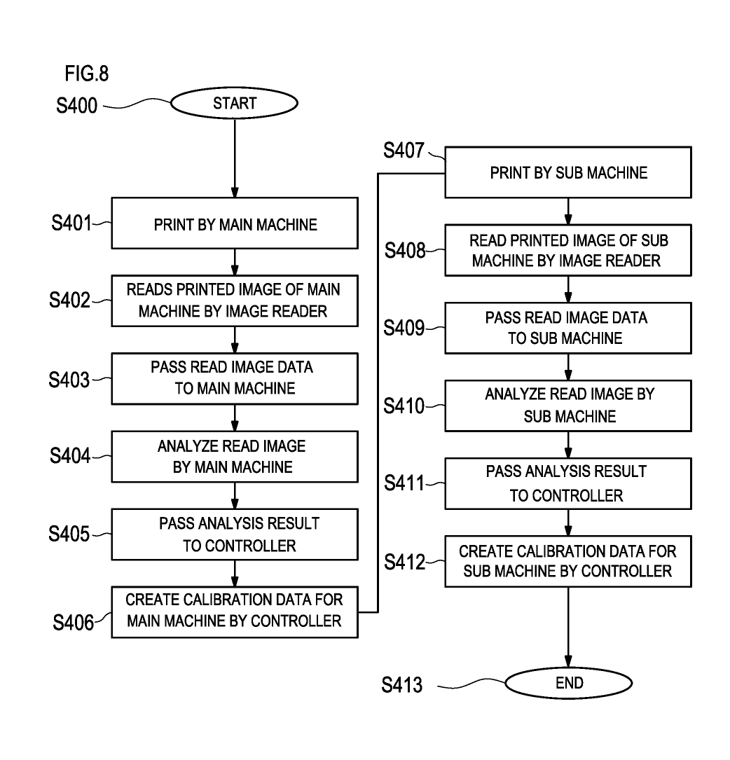

The above operation will be described with reference to the flowchart of FIG. 8.

FIG. 8 is the flowchart showing a procedure in which both data printed and color-measured by the main machine and the sub machine are notified to the system controller and the system controller creates the calibration data for the main machine and the sub machine by using the data.

When the operation is started, the chart image is printed by the main machine to prepare the calibration data for the main machine (step S401). Then, the paper printed by the main machine is conveyed up to the image reader while keeping face up, and the image reader reads the image of the paper (step S402). The image reader transfers the read image to the main machine (step S403), the main machine analyzes the read image (step S404), and passes the analysis result to the controller (step S405). The system controller creates the calibration data for the main machine using the received analysis result (step S406). Here, the creation of the calibration data for the main machine is completed.

Next, calibration data for the sub machine is created. First, the chart image is printed by the sub machine (step S407). Then, the paper printed by the sub machine is conveyed up to the image reader while keeping face up, and the image reader reads the image of the paper (step S408). The image reader transfers the read image to the sub machine (step S409), the sub machine analyzes the read image (step S410), and passes the analysis result to the controller (step S411).

The controller, using the received analysis result, creates the calibration data for the sub machine (step S412), and the creation of the calibration data for the sub machine is completed. After completion of step S412, the procedure ends.

### Embodiment 2

In the above operation, a case where the controller can hold a plurality of calibration data considering the difference between the main machine and the sub machine has been described. When the controller does not consider the difference between the main machine and the sub machine, and has calibration data for one machine (using the same calibration data for both the front side and the back side), the image forming apparatus refers to data printed and color-measured on the main machine and the sub machine respectively, and adjustment is performed on the image forming apparatus sides so that the results output by the main machine and the sub machine are the same. The controller receives the colorimetrically measured data which has no difference between the main machine and the sub machine, and creates one calibration data using the data.

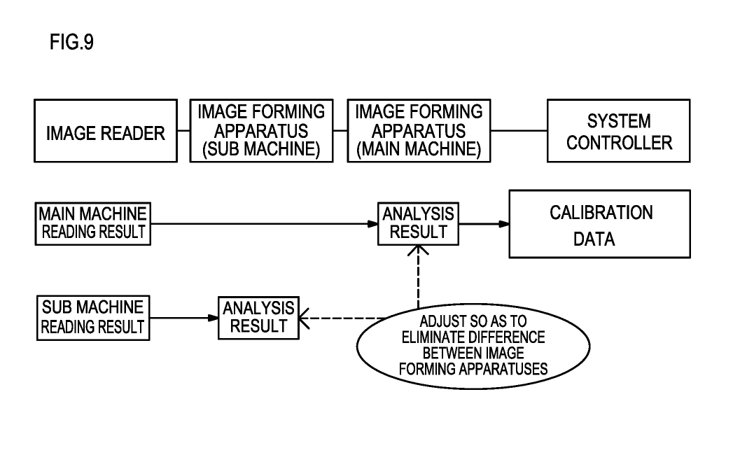

FIG. 9 shows the relationship between the reading result, the analysis result, and the calibration data held by the controller when the controller has calibration data for one machine.

In this case, the reading results of the main machine and the sub machine acquired by the image reader are transmitted to the main machine and the sub machine, respectively. Thereafter, the image forming apparatuses performs adjustment so that the output results of the main machine and the sub machine become the same, and transmits the result to the controller. Adjustment may be performed by one image forming apparatus or by both image forming apparatuses. In this embodiment, it is desirable to perform calibration adjustment on the sub machine so as to match the main machine. The controller creates the calibration data based on the received analysis result.

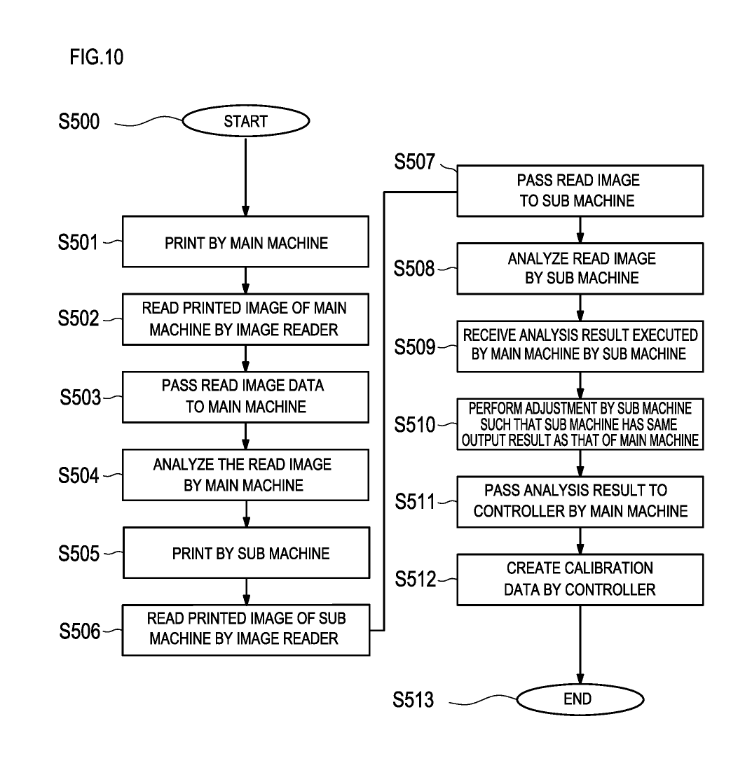

The above operation will be described with reference to the flowchart in FIG. 10.

FIG. 10 is the flowchart showing the procedure for the controller to create calibration data for one machine.

When the operation is started, the chart image is printed by the main machine (step S501). Then, the paper printed by the main machine is conveyed up to the image reader while keeping face up, and the image reader reads the image of the paper (step S502). The image reader transfers the read image to the main machine (step S503), and the main machine analyzes the read image (step S504).

Next, the chart image is printed by the sub machine (step S505). Then, the paper printed by the sub machine is conveyed up to the image reader while keeping face up, and the image reader reads the image of the paper (step S506). The image reader transfers the read image to the sub machine (step S507), and the sub machine analyzes the read image (step S508).

Thereafter, the sub machine receives the analysis result executed by the main machine (step S509), and performs adjustment such that the sub machine has the same output result as that of the main machine (step S510). The main machine passes the analysis result to the controller (step S511), and the controller creates calibration data common to the main machine and the sub machine using the received analysis result (step S512). After that, the procedure ends.

According to the present embodiment, by using only one reader (ICCU) at the time of tandem-connected in series, calibration in the controller for the main machine and the sub machine can be executed in the same way as in the case where the controller refers to the single machine. In other words, the system controller does not need to prepare a chart image for tandem-connected in series, it can use the same algorithm of chart image and calibration as that of the single unit.

That is, according to the present embodiment, in a system in which a plurality of image forming apparatuses are tandem-connected in series, calibration data can be appropriately obtained without performing complicated processing.

The present invention has been described based on the above embodiments, but the scope of the present invention is not limited to the contents of the above-described embodiments, and appropriate modifications to the above embodiment can be made without departing from the scope of the present invention.

Although embodiments of the present invention have been described and illustrated in detail, the disclosed made for purposes of illustration and example only and not limitation. The scope of the present invention should be interpreted by terms of the appended claims.

What is claimed is:

1. An image forming system, in which a plurality of image forming apparatuses each having an image forming unit that forms an image on a recording medium are tandem-connected in series, comprising:
a controller that processes image data used for image formation by the image forming unit and controlling the image forming apparatus, wherein
the controller has a function of outputting an inspection image for obtaining calibration data of the image forming apparatus by the image forming apparatus and enabling acquisition of a reading result read by an image reading unit, and
in the function, the controller prepares data for the inspection image to be output by one image forming apparatus and duplicates the data, transmits one of the original inspection image data and the duplicated inspection image data to each image forming apparatus, and performs control so that image is formed on different transfer media respectively by the respective image forming apparatuses based on the inspection image data received by each image forming apparatus.

2. The image forming apparatus according to claim 1, wherein the image forming apparatuses each have an image forming controller that controls the image forming unit respectively,
the controller has a system controller that processes image data used by each image forming apparatus and controls each image forming apparatus, and each of the image forming controllers.

3. The image forming system according to claim 2, wherein among the plurality of image forming apparatuses, in an image forming apparatus serving as a main machine, the image forming controller provided in the image forming apparatus obtains inspection image data and outputs an inspection image to a recording medium, and duplicates the inspection image data, and the duplicated inspection image data is transmitted to an image forming apparatus serving as a sub machine,
in the image forming apparatus serving as the sub machine, the image forming controller provided in the image forming apparatus outputs an inspection image to a recording medium different from a recording medium used for outputting an inspection image by another image forming apparatus based on the duplicated inspection image data.

4. The image forming system according to claim 1, wherein the controller acquires and analyzes the reading result of an inspection image outputted by each image forming apparatus and performs, based on a result of an analysis, a calibration process of the image forming apparatus from which the inspection image is output.

5. The image forming system according to claim 1, wherein the controller obtains and analyzes the reading result of the inspection image outputted by each image forming apparatus and obtains calibration data of the image forming apparatus based on a result of the analysis.

6. The image forming apparatus according to claim 5, wherein the acquisition of the reading result is performed by the image forming controller of the image forming apparatus from which the inspection image giving the reading result is output, and the result is transmitted to the system controller which processes image data used by each image forming apparatus and controls each image forming apparatus, and the system controller creates calibration data based on the result.

7. The image forming apparatus according to claim 6, wherein the image forming controller of each of the image forming apparatuses performs an analysis based on the reading result and transmits a result of the analysis to the system controller.

8. The image forming system according to claim 4, wherein calibration of each image forming apparatus is performed by the image forming controller provided in each image forming apparatus or by the system controller.

9. The image forming system according to claim 4, wherein the controller adjusts calibration data in at least one image forming apparatus so that a result of the calibration of each image forming apparatus is within a predetermined range.

10. The image forming system according to claim 4, wherein the controller stores each calibration data used for calibration of each image forming apparatus.

11. The image forming system according to claim 4, wherein the controller stores common calibration data used for calibration of each image forming apparatus.

12. The image forming system according to claim 1, wherein when an inspection image is printed by the image forming apparatus at a preceding stage, the controller performs control to send a recording medium on which the inspection image has been formed by the image forming apparatus at the preceding stage to the image forming apparatus on a subsequent stage side without reversing front and back sides of the recording medium, and discharge the recording medium without forming an image by the image forming apparatus at a subsequent stage.

13. The image forming system according to claim 1, wherein when an inspection image is printed by the image forming apparatus at a subsequent stage, the controller performs control to discharge a recording medium supplied by the image forming apparatus on a preceding stage side without forming an image by the image forming apparatus at a preceding stage, send the recording medium to the image forming apparatus on a subsequent stage side, and print the inspection image by one image forming apparatus on the subsequent stage side and discharge the recording medium such that an output face of the image is positioned on the same side as that of an output face of the image from the image forming apparatus at the preceding stage.

14. The image forming system according to claim 1, wherein the image reading unit for reading an image of a recording medium conveyed from an apparatus on a previous stage side is provided at a position on a following stage side than the plurality of image forming apparatuses, and the image reading unit transmits the reading result to the controller.

15. The image forming system according to claim 14, wherein a plurality of inspection images outputted by the plurality of image forming apparatuses are read by a single image reading unit.

16. An image forming control method for controlling image formation by an image forming system, in which a plurality of image forming apparatuses each having an image forming unit that forms an image on a recording medium are tandem-connected in series, comprising;
a function of outputting an inspection image for obtaining calibration data of the image forming apparatus by the image forming apparatus and enabling acquisition of a reading result read by an image reading unit, wherein
in the function, data for the inspection image to be output by one image forming apparatus is prepared and the data is duplicated, and the original inspection image data and the duplicated inspection image data are transmitted to each image forming apparatus, and control is performed so that image is formed on different transfer media respectively by the respective image forming apparatuses based on the inspection image data received by each image forming apparatus.

17. A non-transitory computer-readable recording medium storing a program executed on a computer that controls an image forming system, in which a plurality of image forming apparatuses each having an image forming unit that forms an image on a recording medium are tandem-connected in series, wherein
the program causes the computer to output an inspection image for obtaining calibration data of the image forming apparatus by the image forming apparatus and enable acquisition of a reading result read by the image reading unit,
in the output of the image forming apparatus, prepare data for the inspection image to be output by one image forming apparatus and duplicate the data, transmit the original inspection image data and the duplicated inspection image data to each image forming apparatus, and perform image formation on different transfer media respectively by the respective image forming apparatuses based on the inspection image data received by each image forming apparatus.
